(19) United States
(12) Patent Application Publication
(10) Pub. No.: US 2021/0280167 A1
(43) Pub. Date: Sep. 9, 2021

(54) TEXT TO SPEECH PROMPT TUNING BY EXAMPLE

(71) Applicant: INTERNATIONAL BUSINESS MACHINES CORPORATION, Armonk, NY (US)

(72) Inventors: Maria E. Smith, Davie, FL (US); Radek Kazbunda, Prague (CZ); Michael Alan Picheny, White Plains, NY (US); Raul Fernandez, New York, NY (US)

(21) Appl. No.: 16/808,914

(22) Filed: Mar. 4, 2020

(51) Int. Cl. G10L 13/10; G10L 13/027; G10L 13/033

(52) U.S. Cl. CPC G10L 13/10; G10L 13/0335; G10L 13/027

(57) ABSTRACT

According to one embodiment, a method, computer system, and computer program product for customizing the rendering of a synthesized speech prompt is provided. The present invention may include extracting prosodic information from a received audio recording of a prompt by parsing the text corresponding with the prompt and generating phonetic units, aligning the phonetic units with the audio recording, and calculating, based on the alignment, prosodic values for the phonetic units. The invention may further include adapting the prosodic values to match a text-to-speech voice in use, and then synthesizing speech for the prompt based upon the adapted prosodic information.

### BACKGROUND

The present invention relates, generally, to the field of computing, and more particularly to speech synthesis.

Speech synthesis is the artificial production of human speech by a computer system. As computers become more advanced and more deeply integrated into users' everyday lives, convenient means of interfacing between humans and computers are of increasing interest. Speech is a natural avenue to pursue as a user interface method; after all, it is already the means by which humans primarily interact with other humans. However, the use of speech as an interface method introduces new levels of complexity. Beyond mere intelligibility of synthesized speech, which is crucial in its own right, the rendering of a given phrase conveys a great deal of additional meaning: whether the phrase constitutes a statement, question, or command, the presence of irony or sarcasm, emphasis, contrast, focus, the mood or intent of the speaker, and more. As such, a correct rendering is crucial to the future success of speech synthesis as a human interface method.

### SUMMARY

According to one embodiment, a method, computer system, and computer program product for customizing the rendering of a synthesized speech prompt is provided. The present invention may include extracting prosodic information from a received audio recording of a prompt by parsing the text corresponding with the prompt and generating phonetic units, aligning the phonetic units with the audio recording, and calculating, based on the alignment, prosodic values for the phonetic units. The invention may further include adapting the prosodic values for use with the text-to-speech voice in use, and then synthesizing speech for the prompt based upon the adjusted prosodic information.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a prompt tuning process according to at least one embodiment;

FIG. 3 illustrates an exemplary computing environment executing the prompt tuning process of FIG. 2 according to at least one embodiment;

FIG. 4 illustrates an exemplary computing environment executing the prompt tuning process of FIG. 2 according to at least one embodiment;

FIG. 5 is an operational flowchart illustrating a prompt tuning process according to at least one embodiment;

FIG. 6 illustrates an exemplary computing environment executing the prompt tuning process of FIG. 5 according to at least one embodiment;

FIG. 7 is a block diagram of internal and external components of computers and servers depicted in FIG. 1 according to at least one embodiment;

FIG. 8 depicts a cloud computing environment according to an embodiment of the present invention; and

FIG. 9 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to speech synthesis. The following described exemplary embodiments provide a system, method, and program product to, among other things, analyze recorded speech from a user, extract prosodic information from the recorded speech, and utilize the prosodic information for speech synthesis. Therefore, the present embodiment has the capacity to improve the technical field of speech synthesis by providing a means of incorporating prosodic information from speech recordings to modify and correct the rendering of synthesized speech.

As previously described, speech synthesis is the artificial production of human speech by a computer system. As computers become more advanced and more deeply integrated into users' everyday lives, convenient means of interfacing between humans and computers are of increasing interest. Speech is a natural avenue to pursue as a user interface method; after all, it is already the means by which humans primarily interact with other humans. One method of synthesizing speech is by storing short clips of recorded human speech, from whole words down to individual sounds, and combining these recorded sounds to create words and sentences. Another method involves utilizing a synthesizer which can model the vocal tract and human voice characteristics to create purely artificial speech from scratch. More recent methods involve the use of deep neural networks to predict acoustic features of the speech and to encode the resulting audio.

However, speech synthesis often fails to achieve the desired result; even where synthesized speech comprises all the correct phonemes, synthesis errors can still be enough to render the synthesized speech unintelligible, unsatisfactory or lacking in expressiveness. Synthesized speech may fail to convey any of a host of additional linguistic features that humans rely on for context and clear communication. Such problems are often encountered, for example, by designers for computer applications, where the application needs to say a number of messages (prompts) to the user running the application. For instance, an application may need to ask the user for her account number. However, during testing, the designers often realize that the prompt doesn't sound the way that it was intended. For example, the text-to-speech engine synthesizing the speech from the prompt may place emphasis on the wrong word, pause in inappropriate places or for an inappropriate duration, pronounce a word incorrectly, produce synthesized speech that is technically correct but sounds unnatural, add an awkward inflection, or introduce other flaws to the audio.

Users may try to address such issues by adding punctuation, changing the pronunciation, or changing the text of the prompt in the hope that the text-to-speech engine will be able to synthesize a different prompt correctly. These approaches are inconsistent in their success, and are extremely limited in the control they afford a user over the synthesis of the prompts.

In some cases, these issues might have been addressed by using the original voice talent providing the voice of a given text-to-speech program to record prompts and include these recordings in the generated voice, splicing phrases into the prompt as needed in a method known as “phrase splicing.” However, this option requires the original voice talent to be available, and introduces a significant delay between when the voice talent is available to record and when the corrected recording is available to the user.

Arguably the most useful tool currently available to address synthesis issues is a suite of commands included in the speech synthesis markup language (SSML). SSML commands allow a user finer control over synthesized speech, such as by enabling the user to specify the pronunciation of words in the text, add pauses, specify text normalization rules, change the speaking rate, or alter the base pitch. This can go a long way towards correcting prompts, and where a prompt is already synthesized correctly, SSML commands can still be used to make subtle changes which may include resulting quality.

However, composing SSML text minutely detailing the rendering of synthesized speech is a lengthy and manually intensive process which must be performed on each prompt. In the most difficult cases, a user may spend half an hour tuning an individual prompt. Furthermore, language expertise may be needed to tune difficult prompts; in many cases, it is difficult for casual users to even express what is wrong with the synthesized audio. Common complaints include: “sounds robotic,” “not human-like,” “the tone is all wrong,” et cetera. Without a certain level of linguistics expertise, a user may not know which SSML commands address which problems. Even given time, effort and expertise, SSML commands may still be insufficient to the task of producing the desired quality. As such, it may be advantageous to, among other things, implement a simple and intuitive mechanism by which users can improve the synthesis of specific prompts without any prior knowledge of linguistics or intensive SSML code, by submitting samples of correct audio recordings of incorrectly rendered synthesized speech prompts to a system; this system extracts the prosodic components of the correct audio recording to determine the correct realization, and applies that knowledge to future synthesis of the speech prompt in question.

Used herein, the term “prompt” may be used to refer to a discrete segment of language of any length and in any form, for instance textual or audible, which may be targeted to be rendered as speech by a speech synthesis application, or may correspond to audible speech that has already been rendered.

According to at least one embodiment, the invention is a system for correcting or modifying synthesized speech for a given prompt, which receives an audio recording and corresponding text of the prompt from a user, extracts prosodic information from the audio, associates the prosodic information with the prompt by means of a customization identification, and stores the prosodic information.

In some embodiments, the audio recording may be a recording of a user reading the prompt in a fashion which the user desires the system to emulate when synthesizing speech for the prompt. The user may select the prompt to submit audio recordings for based on imperfections or undesired properties of synthesized speech corresponding with the prompt; for example, in the case of user Dave, Dave may be attempting to program an application to audibly express the line, “Snowfall is expected to reach 10 inches today,” and he would like to hear the number 10 stressed. If the synthesis of this prompt fails to stress 10, Dave may submit a recording of himself reading this prompt with the number 10 emphasized.

In some embodiments, the user may submit an audio recording to customize the synthesis of a prompt; in other words, a prompt may be synthesized as speech correctly, but a user may wish to modify the rendering to convey a different meaning, emotion, or implication, to suit different contexts, to emphasize different words, et cetera. For instance, the word “goodbye” could be pronounced in a variety of different ways depending on context; in a happy context, for example where a text to speech application was able to help a user, “goodbye” pronounced in a cheerful tone with a rising inflection may be most appropriate. Conversely, where a text to speech application was unable to help a user, “goodbye” pronounced with a downward inflection or in a more neutral tone may be desired. In another example, a user may include a pun in the prompt, and may wish the synthesized speech to place greater emphasis on the pun.

In some embodiments, prosodic information may be any information regarding a multitude of linguistic properties that comprise a speech realization, such as intonation, rhythm, stress, and tone. In some embodiments, the prosodic information of the audio recording may be all information necessary to reproduce the realization of the audio recording when synthesizing speech for the corresponding prompt.

In some embodiments, the prosodic information extracted from the audio recording may be associated with the prompt to which it corresponds via a customization identification (ID). The customization ID may be a unique identifier associated with a customization, or rendering of the prompt described by the prosodic information. The customization ID may identify to the system that a customization for the prompt exists, and allows the customization to be specifically invoked, for example where a user desires to utilize a particular realization in synthesizing speech for the prompt. In embodiments where multiple customizations exist for the same prompt, the customization ID may distinguish the customizations from each other and may contain additional information to this end. For instance, the customization ID may contain information regarding the context of the customization; where one customization is pronounced as a command, and another customization is pronounced as a question, the customization ID may identify the former as a “command” and the latter as a “question.” In another example, where one customization is cheerful and uses an upward inflection, another is neutral, and a third is gloomy and uses a downward inflection, the customization ID of each may further read “happy,” “neutral,” and “sad,” respectively.

In some embodiments, the system may be a real-time or near-real-time interactive system. For example, the system may be responsive to user inputs and submissions, and may respond to user inputs and reply to the user in real-time or near-real-time.

In some embodiments, the system may prompt the user to submit the audio recording and corresponding text. In other embodiments, the system may provide the user with a graphical user interface for submitting the audio recording and corresponding text of the prompt. In some embodiments, the system may prompt or enable the user to record multiple audio recordings for the prompt, and may allow the user to hear synthesized output resulting from each of the recordings and enable the user to select the preferred one to keep for customization.

In some embodiments, the system may receive prompts that contain fixed and dynamic language. Such prompts may be lines where one subset of the prompt occurs unchanged in synthesis requests, while another subset of the prompt changes across multiple instances. The subsection of the prompt that occurs unchanged may be fixed, while the subsection of the prompt that changes across instances may be dynamic. For example, the prompt “Your account balance is 802.32 dollars” may occur multiple times with a different dollar number in the account balance; in such case, the subsection of the phrase “your account balance is . . . ” and “ . . . dollars” may be the fixed language, and the number, here “802.32,” may be the dynamic language. In some embodiments, the system may receive the audio recording and/or corresponding text already flagged as containing fixed/dynamic language, and/or with fixed/dynamic language sections specifically identified by a user or administrator. In some embodiments, the system may identify the presence of fixed or dynamic language by reading the flags associated with the prompt or by automatically detecting the presence of or a likelihood of fixed dynamic language; for instance, the system may automatically detect subsections that are typically dynamic such as currency amounts or dates. In some embodiments, the system may query the user as to whether such subsections should be flagged as dynamic.

In some embodiments, for example where fixed and dynamic language has been identified, the system may only extract prosodic information from the audio recording corresponding with the fixed subset or subsets of the prompt; because the fixed subset is the only subset that would reoccur, extracting prosodic information from the entire prompt including the dynamic subset would result in a customization that could not be applied to instances of the prompt where only the dynamic language has changed. In some embodiments, the system may separately extract prosodic information from the dynamic subset and the fixed subset, and may store the renderings of the two subsets as separate customizations, with separate customization IDs.

In some embodiments, the system may adapt the prosodic information of a customization to the individual voice being used to synthesize speech. Speech synthesis programs may use any number of voices; in order to integrate the prompt with any number of speech synthesis programs, or any number of possible voices, the system may adapt the prosodic information to match the voice being used to synthesize the speech. Adapting the prosodic information may include uniformly adjusting the pitches contained in the prosodic information of the customization to match the vocal range of the voice being used.

According to at least one embodiment, the invention is a system that extracts prosodic information from an audio recording of a prompt by parsing the text corresponding with the prompt and generating phonetic units, aligning the phonetic units with the audio recording, and calculating, based on the alignment, prosodic values for at least one of the phonetic units.

In some embodiments, the phonetic units may be distinct sounds which, when combined together, create speech. The system may use any units that correspond to the distinctive sounds of a language. For example, the system may use phonemes as the phonetic units, which may be the minimal categorical unit of sound that can be used to distinguish between words in a language. However, in some embodiments, the phonetic units may be smaller (for example, subphonemes), or larger, for instance including combinations of sounds such as phonemes, syllables, et cetera. In the context of text, phonetic units may be the sounds represented by each letter and/or word of the text.

In some embodiments, parsing the plurality of received text into phonetic units may include processing the received text to identify each phonetic unit, or segment of sound, represented by the text. For example, the system may identify and delineate every individual syllable represented by the received text.

In some embodiments, the prosodic values may be the numerical values or metrics by which the prosodic information is enumerated. In some embodiments, the prosodic values may be the starting and ending pitch of a phonetic unit, and/or any representation of pitch within the phonetic unit. The prosodic values may include measures of volume or energy at points within the phonetic unit, duration of a phonetic unit, et cetera. Prosodic values may represent additional speech features such as stress, vowel length, et cetera.

According to at least one embodiment, the invention is a system for synthesizing speech for a previously corrected or modified prompt by receiving a customization identification, extracting stored prosodic information corresponding with the received customization identification, and synthesizing speech for the prompt based on the extracted prosodic information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to analyze recorded speech from a user, extract prosodic information from the recorded speech, and utilize the prosodic information for speech synthesis.

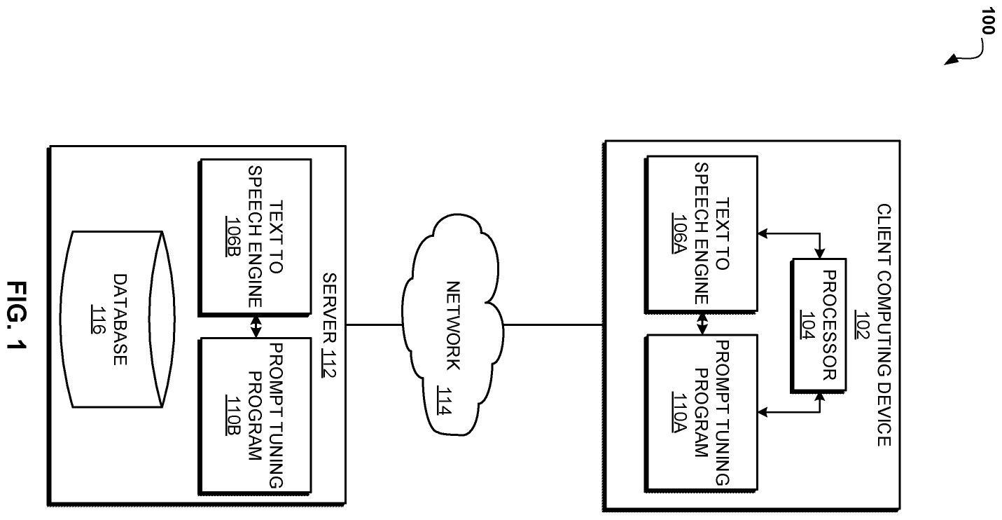

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

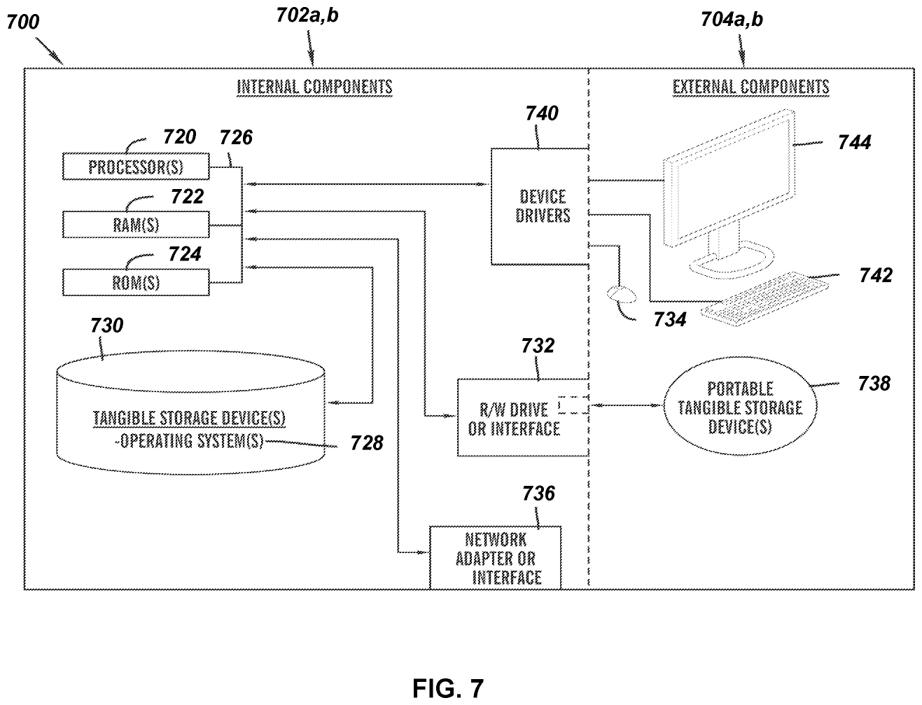

Client computing device 102 may include a processor 104 that is enabled to host and run a text to speech engine 106A and a prompt tuning program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 7, the client computing device 102 may include internal components 702a and external components 704a, respectively.

The server computer 112 may be a laptop computer, netbook computer, personal computer (PC), a desktop computer, or any programmable electronic device or any network of programmable electronic devices capable of hosting and running a text to speech engine 106B and a prompt tuning program 110B and a database 116 and communicating with the client computing device 102 via the communication network 114, in accordance with embodiments of the invention. As will be discussed with reference to FIG. 7, the server computer 112 may include internal components 702b and external components 704b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

According to the present embodiment, the text to speech engine 106A, 106B may be a program enabled to synthesize human speech from text. In some embodiments, text to speech engine 106A, 106B may be enabled to convert normal language text into speech, and/or to convert symbolic linguistic representations such as phonetic transcriptions. The text to speech engine 106A, 106B may be located on client computing device 102 or server 112 or on any other device located within network 114. Furthermore, text-to-speech engine 106A, 106B may be distributed in its operation over multiple devices, such as client computing device 102 and server 112. The text to speech engine 106A, 106B may operate or otherwise be in communication with a speaker capable of reproducing human speech.

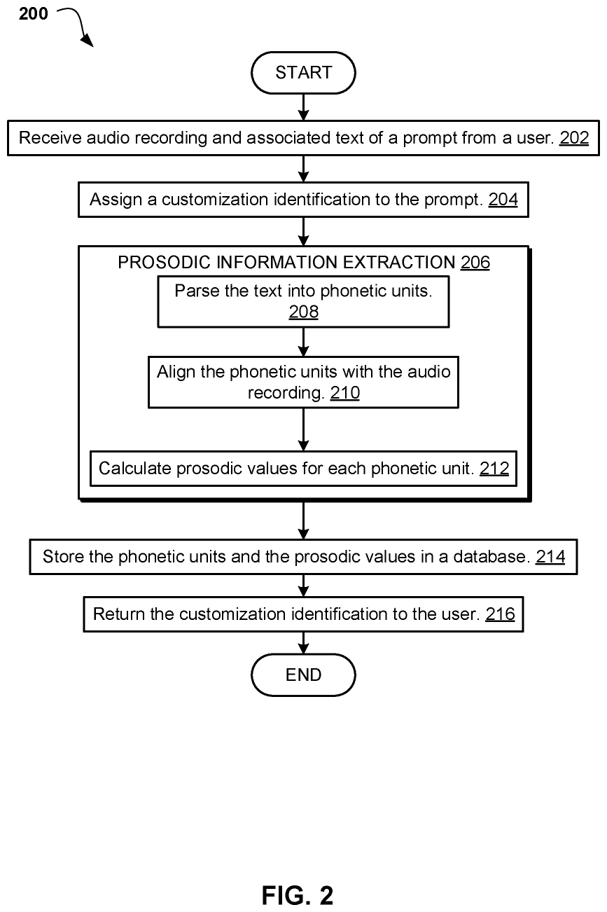

According to the present embodiment, the prompt tuning program 110A, 110B may be a program enabled to analyze recorded speech from a user, extract prosodic information from the recorded speech, and utilize the prosodic information for speech synthesis. The prompt tuning program 110A, 110B may be located on client computing device 102 or server 112 or on any other device located within network 114. Furthermore, prompt tuning program 110A, 110B may be distributed in its operation over multiple devices, such as client computing device 102 and server 112. The prompt tuning program 110A, 110B may be a subroutine or otherwise integrated into text to speech engine 106A, 106B, or may be a separate and/or standalone program. The prompt tuning program 110A, 110B is depicted as being located on the same computing device as text to speech engine 106A, 106B, but may be located on different computing devices relative to text to speech engine 106A, 106B. The prompt tuning method is explained in further detail below with respect to FIG. 2.

Referring now to FIG. 2, an operational flowchart illustrating a prompt tuning process 200 is depicted according to at least one embodiment. At 202, the prompt tuning program 110A, 110B receives an audio recording and associated text of a prompt from a user. The audio recording may comprise the same words as the text, and both the text and the audio recording may comprise the same words as the prompt. While an advantage of the prompt tuning process 200 is that it simplifies the process of adjusting a prompt for a user to the mere step of submitting an audio recording and corresponding text, it may be desirable in some embodiments (for example, where there are multiple audio recordings corresponding to the same prompt that could benefit by being distinguished from one another, or where an audio recording is best suited to a particular context), to request or accept additional information from the user; in some embodiments, the user may further submit information describing the audio recording, such as the context, part of speech, or intended emotion to be conveyed by the user's reading of the prompt. For instance, the user may indicate if the rendering is intended to convey sarcasm or irony, anger, incredulity, happiness, et cetera. The user may indicate whether the rendering casts the prompt as a command, query, statement, et cetera.

Next, at 204, the prompt tuning program 110A, 110B assigns an identification number (ID) to the prompt. The ID may be a unique identifier associated with a customization, or rendering of the prompt described by the prosodic information. In some embodiments, such as where the user has contributed additional information, prompt tuning program 110A, 110B may incorporate the additional information into the ID, or otherwise associate the information with the ID.

At 206, prompt tuning program 110A, 110B performs prosodic information extraction. Prosodic information extraction is a process of extracting useful information from the audio recording and associated text, and may comprise the steps of parsing text and generating phonetic units, aligning these phonetic units with the audio, and calculating prosodic values for each phonetic unit.

At 208, prompt tuning program 110A, 110B parses the text into phonetic units. Parsing the text into phonetic units may include processing the received text to identify each phonetic unit, or segment of sound, represented by the text. For example, prompt tuning program 110A, 110B may identify and delineate every individual syllable represented by the received text. Where a word can be pronounced in multiple different ways, such as, for example, the word “bass,” prompt tuning program 110A, 110B may consult a dictionary of possible pronunciations for a word to determine possible or probable combinations of phonetic units that the word may represent.

At 210, prompt tuning program 110A, 110B aligns the phonetic units with the audio recording. Here, prompt tuning program 110A, 110B identifies the location of each phonetic unit within the audio. Since the text is a written transcript of the audio, the phonetic units generated from the text must therefore be found in the audio. In some number of cases, the audio recording may contain additional sounds or rests not represented in the text, which therefore have no textual counterpart. For example, in the audio recording, the user may insert filler words such as “um” or “err,” sounds such as derisive snorts or laughter, stuttering, et cetera. In some embodiments, the prompt tuning program 110A, 110B may utilize paralinguistic detection methods to identify these non-speech components of the audio recording, and may flag these paralinguistic phonetic units. For instance, where prompt tuning program 110A, 110B records transcription text of the audio, the transcription text may include markers in any markup language to indicate where these sounds are located. For example, the transcription text may read “<hmm> That doesn't seem right,” where prompt tuning program 110A, 110B identifies the paralinguistic sound (“hmm”) with angle brackets. In some embodiments, the identified paralinguistic components may be disregarded during the process of matching corresponding phonetic units in the text and audio, as paralinguistic components may not match the text. In some embodiments, even where identified paralinguistic components are disregarded for purposes of matching phonetic units, paralinguistic components may be included in the synthesized output.

At 212, prompt tuning program 110A, 110B calculates prosodic values for each phonetic unit. Once prompt tuning program 110A, 110B has aligned the phonetic units to the audio recording, prompt tuning program 110A, 110B may calculate the prosodic values by measuring any quality of the audio that pertains to the rendering of the audio recording. For example, the prompt tuning program 110A, 110B may measure the pitch at the beginning and/or end of the phonetic unit, and/or the pitch at any number of points within the phonetic unit. The prompt tuning program 110A, 110B may measure the volume or energy at points within the phonetic unit, the duration of a phonetic unit, and other speech features such as stress, vowel length, et cetera.

At 214, prompt tuning program 110A, 110B stores the phonetic units and prosodic values in a database. The prompt tuning program 110A, 110B may store the phonetic units and prosodic values as a customization, and in some embodiments, such as where the user has submitted additional information pertaining to the audio recording, may store the user-submitted information as well.

At 216, prompt tuning program 110A, 110B returns the customization information to the user. In some embodiments, prompt tuning program 110A, 110B may return the customization, comprising the prosodic information, to the user so that the user may employ the prosodic information or modify it further. In some embodiments of the invention, the customization information may be instead, or additionally, passed to a speech synthesizer program to be played audibly as synthesized speech.

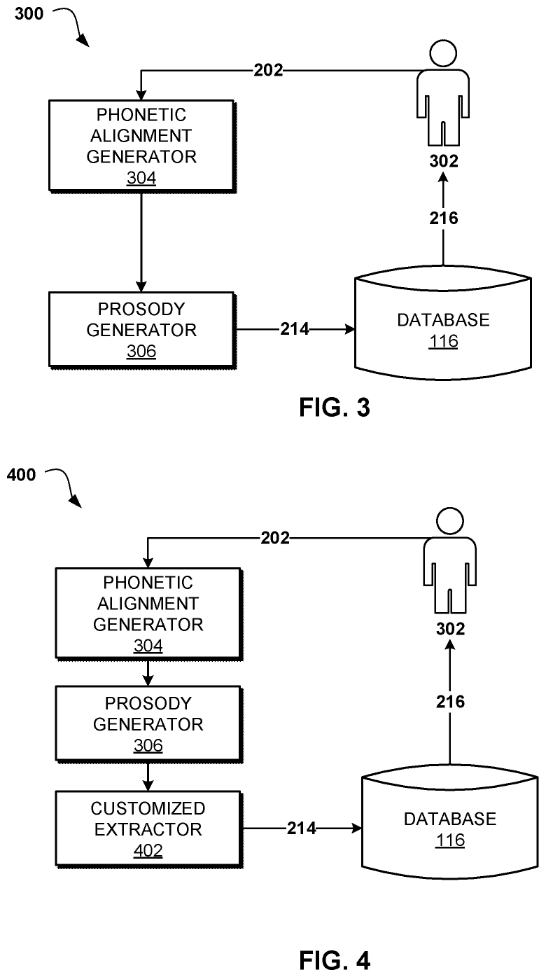

Referring now to FIG. 3, an exemplary computing environment 300 executing the prompt tuning process of FIG. 2 is depicted according to at least one embodiment. The user 302 provides the phonetic alignment generator 304 with an audio recording and associated text of a prompt as in step 202 of FIG. 2. User 302 may be any user of the prompt tuning program 110A, 110B, including human users as well as programs or services. The phonetic alignment generator 304 may parse the text and generate phonetic units as in step 208, and may align the parsed phonetic units as in step 210. The phonetic alignment generator 304 may then pass the aligned phonetic units to the prosody generator 306. The prosody generator 306 calculates prosodic values for each phonetic unit, as in step 212, and then passes its output to database 116, as in step 214 of FIG. 2. The prompt tuning program 110A, 110B then provides the user 302 with the customization identification from the database 116.

Referring now to FIG. 4, an exemplary computing environment 400 executing the prompt tuning process of FIG. 2 is depicted according to at least one embodiment. The computing environment 400 is identical to computing environment 300 except for the inclusion of a customized extractor 402. The customized extractor 402 identifies fixed and dynamic language within the prompt, and extracts the dynamic sections of the prompt, such that the prosodic information is not stored for the dynamic text and the rendering of the dynamic sections is not customized. In some embodiments, the customized extractor 402 may simply delineate between the fixed and dynamic text but maintain the prosodic information for both, so that the customization will be applied to the entire prompt but if the dynamic text changes, the customization may still be applied to the fixed text.

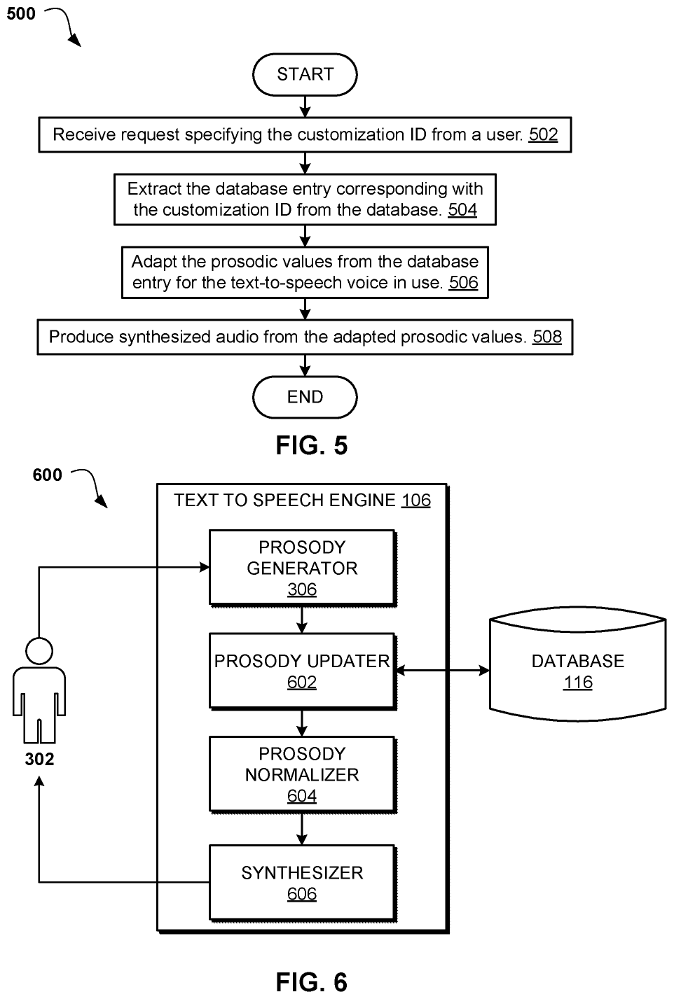

Referring now to FIG. 5, an operational flowchart illustrating a prompt tuning process 500 is depicted according to at least one embodiment. At 502, prompt tuning program 110A, 110B receives a request specifying the customization ID from a user. The request may be in any computer-readable format, be it code, a written request by the user, et cetera. The request may be in the form of an SSML mark-up containing a customization ID as a tag. For example, a customization associated with customization ID 7584 and modifying the prompt “Welcome to ABC Bank” could be invoked in SSML via the command <custom id=7584>Welcome to ABC Bank</custom>.

At 504, prompt tuning program 110A, 110B extracts the database entry corresponding with the customization ID from the database 116. The prompt tuning program 110A, 110B may parse an index of the database 116 to identify the address of the customization pertaining to the customization ID, and retrieve the customization for use.

At 506, prompt tuning program 110A, 110B adapts the prosodic values from the database entry for the text-to-speech (TTS) voice in use. Text-to-speech engine 106 may be utilizing a particular voice, either by default, user selection, or for any other reason, which differs from the voice recorded in the audio recording, and therefore from the prosodic information extracted from the audio recording. As such, prompt tuning program 110A, 110B may adapt the customization to match the voice being used by text to speech engine 106. The prompt tuning program 110A, 110B may, for instance, adapt the prosodic information by adjusting the pitches contained in the prosodic information of the customization to match the vocal range of the voice being used by text to speech engine 106. The prompt tuning program 110A, 110B may adjust the speaking rate to match that of the voice in use. In some embodiments, the prompt tuning program 110A, 110B may adjust other prosodic features for use with the voice.

At 508, prompt tuning program 110A, 110B produces synthesized audio from the adapted prosodic values. The prompt tuning program 110A, 110B may convert the prosodic values into speech by any method, for instance by concatenating pieces of recorded speech stored in a database, and modifying these pieces of recorded speech with the prosodic information. In some embodiments, the synthesized output may be produced by using neural network models to predict acoustic features which are then used by a neural vocoder to generate the speech. In some embodiments, the prompt tuning program 110A, 110B may pass the prosodic values to text-to-speech engine 106 or another program or service to perform the speech synthesis.

Referring now to FIG. 6, an exemplary computing environment 600 executing the prompt tuning process of FIG. 5 is depicted according to at least one embodiment. User 302 provides an SSML input text to prosody generator 306. The prosody generator 306 generates uncustomized prosody information for the full text and provides the uncustomized prosody information to prosody updater 602. Uncustomized prosody may be prosodic information created for a prompt in the process of speech synthesis that has not been customized by recorded audio from a user. Prosody updater 602 replaces the prosody of the customized portion with values in database 116. Prosody updater 602 then passes the updated prosody to the prosody normalizer 604, which further adjusts the prosody of the customized portion to match TTS voice pitch and speaking rate. The prosody normalizer 604 then passes the adjusted prosody information to the synthesizer 606, which utilizes the adjusted prosody information to synthesize audible speech, and play the synthesized speech back to the user. The prosody generator 306, prosody updater 602, prosody normalizer 604, and synthesizer 606 are herein depicted as subroutines or components of text to speech engine 106, but in other embodiments may be external to text to speech engine 106 in any combination.

It may be appreciated that FIGS. 2-6 provides only illustrations of individual implementations and do not imply any limitations with regard to how different embodiments may be implemented. Many modifications to the depicted environments may be made based on design and implementation requirements.

FIG. 7 is a block diagram 700 of internal and external components of the client computing device 102 and the server 112 depicted in FIG. 1 in accordance with an embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

The data processing system 702, 704 is representative of any electronic device capable of executing machine-readable program instructions. The data processing system 702, 704 may be representative of a smart phone, a computer system, PDA, or other electronic devices. Examples of computing systems, environments, and/or configurations that may represented by the data processing system 702, 704 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 702 a,b and external components 704 a,b illustrated in FIG. 7. Each of the sets of internal components 702 include one or more processors 720, one or more computer-readable RAMs 722, and one or more computer-readable ROMs 724 on one or more buses 726, and one or more operating systems 728 and one or more computer-readable tangible storage devices 730. The one or more operating systems 728, the software program 108 and the prompt tuning program 110A in the client computing device 102, and the prompt tuning program 110B in the server 112 are stored on one or more of the respective computer-readable tangible storage devices 730 for execution by one or more of the respective processors 720 via one or more of the respective RAMs 722 (which typically include cache memory). In the embodiment illustrated in FIG. 7, each of the computer-readable tangible storage devices 730 is a magnetic disk storage device of an internal hard drive. Alternatively, each of the computer-readable tangible storage devices 730 is a semiconductor storage device such as ROM 724, EPROM, flash memory or any other computer-readable tangible storage device that can store a computer program and digital information.

Each set of internal components 702 a,b also includes a R/W drive or interface 732 to read from and write to one or more portable computer-readable tangible storage devices 738 such as a CD-ROM, DVD, memory stick, magnetic tape, magnetic disk, optical disk or semiconductor storage device. A software program, such as the prompt tuning program 110A, 110B, can be stored on one or more of the respective portable computer-readable tangible storage devices 738, read via the respective R/W drive or interface 732, and loaded into the respective hard drive 730.

Each set of internal components 702 a,b also includes network adapters or interfaces 736 such as a TCP/IP adapter cards, wireless Wi-Fi interface cards, or 3G or 4G wireless interface cards or other wired or wireless communication links. The software program 108 and the prompt tuning program 110A in the client computing device 102 and the prompt tuning program 110B in the server 112 can be downloaded to the client computing device 102 and the server 112 from an external computer via a network (for example, the Internet, a local area network or other, wide area network) and respective network adapters or interfaces 736. From the network adapters or interfaces 736, the software program 108 and the prompt tuning program 110A in the client computing device 102 and the prompt tuning program 110B in the server 112 are loaded into the respective hard drive 730. The network may comprise copper wires, optical fibers, wireless transmission, routers, firewalls, switches, gateway computers and/or edge servers.

Each of the sets of external components 704 a,b can include a computer display monitor 744, a keyboard 742, and a computer mouse 734. External components 704 a,b can also include touch screens, virtual keyboards, touch pads, pointing devices, and other human interface devices. Each of the sets of internal components 702 a,b also includes device drivers 740 to interface to computer display monitor 744, keyboard 742, and computer mouse 734. The device drivers 740, R/W drive or interface 732, and network adapter or interface 736 comprise hardware and software (stored in storage device 730 and/or ROM 724).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

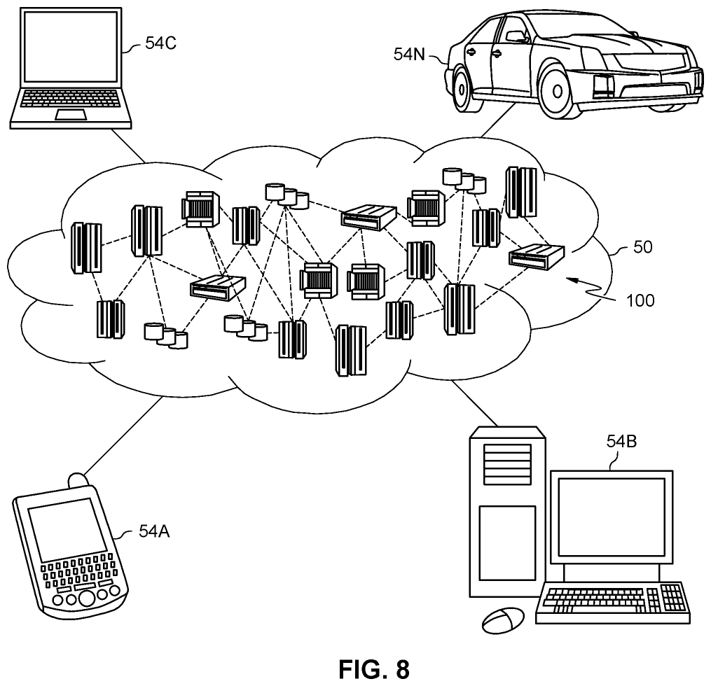

Referring now to FIG. 8, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 100 and cloud computing environment 50 can communicate with any type of computerized device over any type of network and/or network addressable connection (e.g., using a web browser).

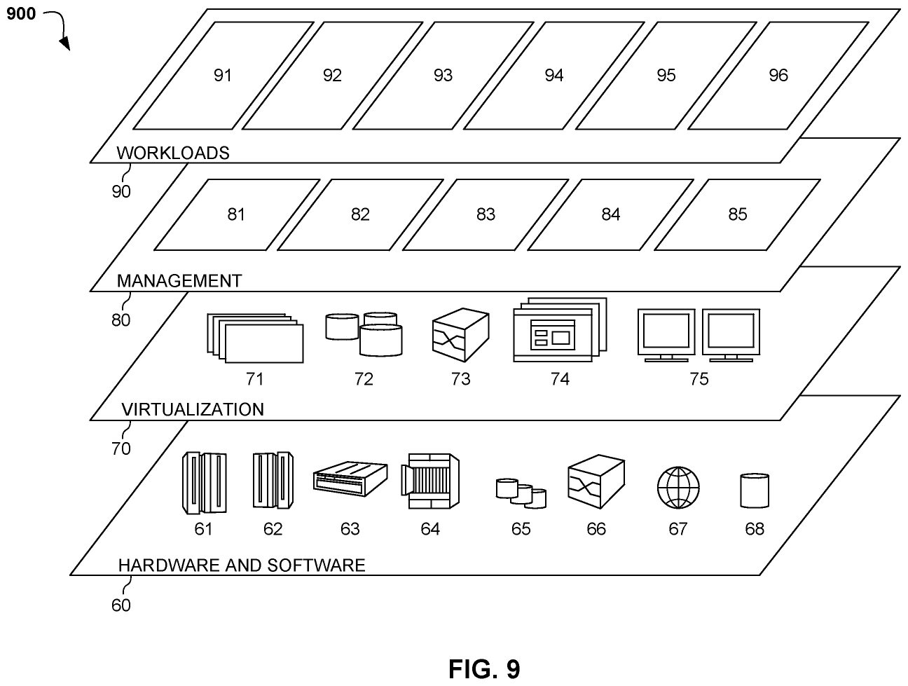

Referring now to FIG. 9, a set of functional abstraction layers 900 provided by cloud computing environment 50 is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and prompt tuning 96. The prompt tuning 96 may be enabled to analyze recorded speech from a user, extract prosodic information from the recorded speech, and utilize the prosodic information for speech synthesis.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for customizing the rendering of a synthesized speech prompt, the method comprising:
extracting a plurality of prosodic information from a received audio recording of a prompt; and
synthesizing speech for the prompt based upon the plurality of prosodic information.

2. The method of claim 1, further comprising: receiving a plurality of text of the prompt.

3. The method of claim 2, further comprising:
identifying at least one subset of the prompt as dynamic and at least one subset of the prompt as fixed.

4. The method of claim 3, wherein extracting a plurality of prosodic information is performed only on the subset of the audio recording that corresponds to the fixed subset of the plurality of text.

5. The method of claim 1, further comprising:
associating the prosodic information with the prompt by means of a unique customization identification.

6. The method of claim 5, wherein the unique identification further comprises a context of the received audio recording.

7. The method of claim 1, further comprising:
adapting the prosodic information to match a text-to-speech voice.

8. A computer system for customizing the rendering of a synthesized speech prompt, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
extracting a plurality of prosodic information from a received audio recording of a prompt; and
synthesizing speech for the prompt based upon the plurality of prosodic information.

9. The computer system of claim 8, further comprising:
receiving a plurality of text of the prompt.

10. The computer system of claim 9, further comprising:
identifying at least one subset of the prompt as dynamic and at least one subset of the prompt as fixed.

11. The computer system of claim 10, wherein extracting a plurality of prosodic information is performed only on the subset of the audio recording that corresponds to the fixed subset of the plurality of text.

12. The computer system of claim 8, further comprising:
associating the prosodic information with the prompt by means of a unique customization identification.

13. The computer system of claim 12, wherein the unique identification further comprises a context of the received audio recording.

14. The computer system of claim 8, further comprising:
adapting the prosodic information to match a text-to-speech voice.

15. A computer program product for customizing the rendering of a synthesized speech prompt, the computer program product comprising:
one or more computer-readable tangible storage medium and program instructions stored on at least one of the one or more tangible storage medium, the program instructions executable by a processor to cause the processor to perform a method comprising:
extracting a plurality of prosodic information from a received audio recording of a prompt; and synthesizing speech for the prompt based upon the plurality of prosodic information.

16. The computer program product of claim 15, further comprising:
receiving a plurality of text of the prompt.

17. The computer program product of claim 16, further comprising:
identifying at least one subset of the prompt as dynamic and at least one subset of the prompt as fixed.

18. The computer program product of claim 17, wherein extracting a plurality of prosodic information is performed only on the subset of the audio recording that corresponds to the fixed subset of the plurality of text.

19. The computer program product of claim 15, further comprising:
associating the prosodic information with the prompt by means of a unique customization identification.

20. The computer program product of claim 19, wherein the unique identification further comprises a context of the received audio recording.

21. The computer program product of claim 15, further comprising:
adapting the prosodic information to match a text-to-speech voice.

22. A method for synthesizing speech for a customized prompt, the method comprising:
extracting stored prosodic information for the customized prompt corresponding with a received customization identification;
adapting the prosodic information to match a text-to-speech voice; and
synthesizing speech for the prompt based on the extracted prosodic information.

23. A method for extracting prosodic information from an audio recording of a prompt, the method comprising:
parsing the plurality of received text corresponding with the prompt into one or more phonetic units;
aligning the phonetic units with the audio recording; and
calculating, based on the alignment, one or more prosodic values for at least one of the plurality of phonetic units.

24. The method of claim 23, further comprising paralinguistic detection.

25. The method of claim 23, wherein the one or more prosodic values enumerate one or more prosodic qualities of a phonetic unit selected from a list consisting of:
a duration, a starting pitch, an ending pitch, a volume, and an additional speech feature.
